(19) United States
(12) Patent Application Publication
(10) Pub. No.: US 2007/0161368 A1
(43) Pub. Date: Jul. 12, 2007

(54) Method for searching a function option of a mobile communication device

(75) Inventor: Jeef Jeng, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/329,246

(22) Filed: Jan. 11, 2006

(51) Int. Cl. H04M 3/00

(52) U.S. Cl. 455/418

(57) ABSTRACT

The present invention is to provide a method for searching a function option of a mobile communication device having a search program including a search procedure and a search look up table, wherein the search look up table includes a plurality of setting signals and a plurality of function options, and each setting signal corresponds to one of the function options. After the mobile communication device receives an external signal, the method executes the steps of executing a search procedure after a search signal being received; letting the search program check whether or not a setting signal matches with the external signal in the search look up table; and reading the function option matching with the setting signal and displaying the function option on the mobile communication device.

### FIELD OF THE INVENTION

The present invention relates to a method for searching a function option of a mobile communication device, and more particularly to a method for searching a function option of a mobile communication device that allows users to search their desired function quickly.

### BACKGROUND OF THE INVENTION

The blooming telecommunication industry has a significant influence to our daily life, and most people cannot live without communications. Unquestionably, our life will be closely related to wireless terminals, fixed networks (fixed communication network service) and computer networks in the future. In the telecommunication industry, the wireless terminals (such as mobile phones) have the fastest growth from ten million users five years ago to a billion users now, and the importance of the mobile phone is predicted to be far beyond the importance of the fixed telephone, and thus it is a trend for telecommunication companies to provide full communication services and offer add-on values to mobile phones including the applications in the area of financial information, weather report, email, stock information, etc, so as to compete with others in the market of severe competitions.

Therefore, new mobile communication equipments are introduced constantly. People not only pay attention to the appearance and overall design of a mobile phone, but also demand more varieties on its functions. Particularly in recent years, mobile phones become increasingly popular, and manufacturers put lots of efforts on minimizing the size of their products. Besides reducing the size, the mobile phones also come with many more functions, and the voice transmission function of the mobile phone has become a “basic function”, and there are many other functions including calendar, calculator, date, photo, game, setting, etc.

To allow users to select an option, a prior art mobile phone 1 as shown in FIG. 1 includes a display screen 10 for displaying a function list 12, and the function list 12 includes a plurality of function groups 14, and each function group 14 includes a plurality of function options. If a user wants to select a function option (such as telephone directory) from a function group 14, then the display screen 10 will display the function option (such as “add”, “modify” and “delete”, etc) of the function group 14, so that the user can select the desired function option.

Although the variety provides extensive applications to the mobile phones, their operation may not be convenient. Even a mobile phone with very simple functions comes with more than 20 function options, so that when a user-wants to select one of the function options of the mobile phone 1 and does not know which function group 14 is the function option located, the user has to use the mobile phone 1 to display the function list 12 and select the function groups 14 one by one. If the function option cannot be found, the user has to return to the screen that shows the function list 12 of the display screen 10 to select those unselected function group 14 again until the user finds the desired function option.

From the operation procedure as described above, users spend lots of time on the process before they can use a function. Supposed that the mobile phone 1 has over 50 functions, it is very inconvenient and complicated for users to search the desired function option by the aforementioned method. To assure the market share, manufacturers have to design a user-friendly and convenient mobile phone. Under the current trend of a mobile phone having so many functions, a method for rapidly searching the user's desired function option definitely will be appreciated by both consumers and manufacturers.

### SUMMARY OF THE INVENTION

In view of the complicated procedure and inconvenience of selecting the function option according to the prior art, the inventor of the present invention based on years of experience of the related industry to conduct extensive researches and experiments, and finally invented a method for searching a function option of a mobile communication device in accordance with the present invention, so that users can search their desired function quickly.

Therefore, it is a primary objective of the present invention to provide a method for searching a function option of a mobile communication device, wherein the mobile communication device includes a microprocessor and a memory unit, and the memory unit includes a search program, and the search program includes a search procedure and a search look up table, and the search look up table includes a plurality of setting signals and a plurality of function options, and each setting signal matches with a function option and has a function name representing each corresponding function option. After the microprocessor receives an external signal and a search signal, a search procedure will be executed, and the search program will check whether or not a setting signal in the search look up table matches with the external signal. If a setting signal matching with the external signal is found, the function option corresponding to the setting signal will be read and displayed on the mobile communication device, so that a user can search the desired function quickly, and select the function option to greatly shorten the time for searching the function option.

The above and other objects, features and advantages of the present invention will become apparent from the following detailed description taken with the accompanying drawings.

### BRIEF DESCRIPTION OF THE DRAWINGS

FIG. 1 is a schematic view of a function list displayed on a prior art mobile phone;

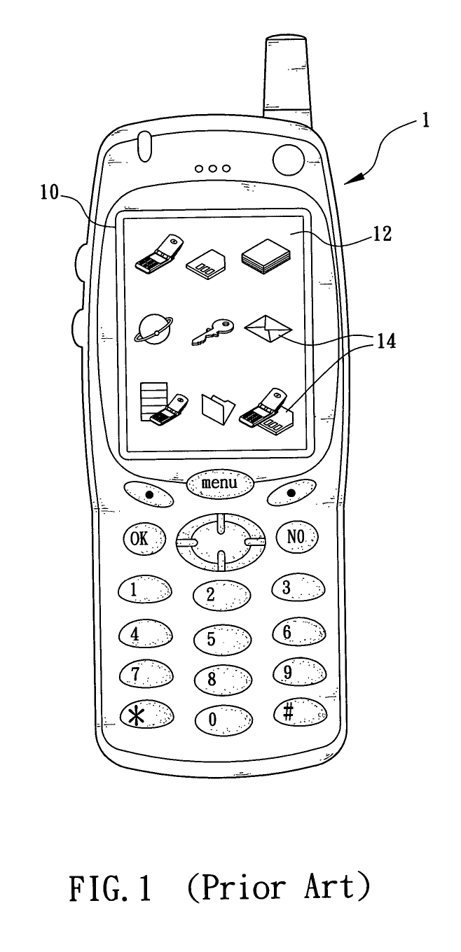

FIG. 2 is a block diagram of a mobile communication device of the present invention;

FIG. 3 is a flow chart of a searching method of the present invention; and

FIG. 4 is a flow chart of a resetting procedure of a searching method of the present invention.

### DETAILED DESCRIPTION OF THE PREFERRED EMBODIMENTS

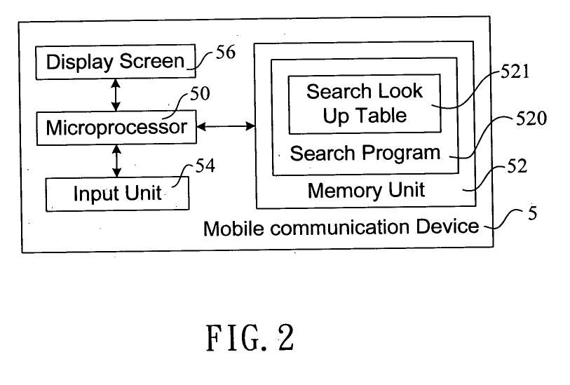

Referring to FIG. 2 for the method for searching a function option of a mobile communication device according to the present invention, a mobile communication device 5 includes a microprocessor 50 and a memory unit 52, and the memory unit 52 includes a search program 520, and the search program 520 includes a search procedure and a search look up table 521, and the search look up table 521 includes a plurality of setting signals and a plurality of function options, and each setting signal represents the function name of each function option and matches with a function option. After the microprocessor 50 receives an external signal-and a search signal, the search procedure will be executed and the search program 520 will check whether or not any setting signal in the search look up table 521 matches with the external signal. If the setting signal matching with the external signal is found, the setting signal will be read and displayed on the mobile communication device 5, so that a user can search the desired function quickly and select the desired function option to greatly shorten the time for searching the function option.

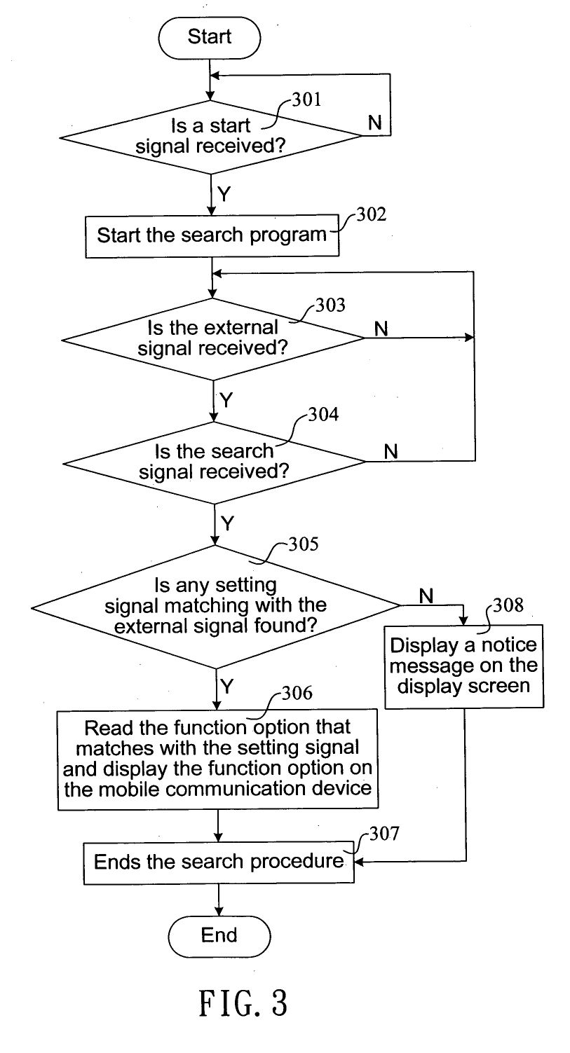

In the present invention as shown in FIGS. 2 and 3, each external signal and each setting signal represent the function name of each function option. To make the description of the method of the present invention clear, the processing and determining procedures of the microprocessor 50 if a user of the mobile communication device 5 wants to search a desired function option are described as follows:

Step 301: determining whether or not a start signal is received; if yes, carrying out step 302; and if no, continuing Step 301;

Step 302: Starting a search program 520;

Step 303: determining whether or not the external signal is received; if yes, then carrying out Step 304; and if no, continuing Step 303;

Step 304: determining whether or not the search signal is received; if yes, carrying out Step 305; and if no, continuing Step 303;

Step 305: executing a search procedure and letting the search program 520 check whether or not any setting signal in the search look up table 521 matches with the external signal according to the external signal; if yes, carrying out Step 306, or else carrying out Step 308;

Step 306: reading the function option that matches with the setting signal and displaying the function option on the mobile communication device 5; and

Step 307: ending the search procedure.

After the function option is displayed on the mobile communication device 5 and the microprocessor 50 receives a select signal again, the procedure of matching the function option will be executed.

In the preferred embodiment as shown in FIG. 2, the start signal, external signal, search signal, and select signal are produced by pressing an input unit 54 of the mobile communication device 5, wherein a character string in the external signal can be read by the microprocessor 50, and a character string in the setting signals is searched according to the character string. If the character string in the external signal is identical to the character string in the setting signal, then the function option matching with the setting signal will be read and the function option will be displayed on a display screen 56 of the mobile communication device 5.

In the preferred embodiment as shown in FIG. 2, the function options include a plurality of main function options and a plurality of sub-function option and each main function option matches with a plurality of sub-function options. After the main function option is displayed on the display screen 56, and the microprocessor 50 receives the select signal, the microprocessor 50 will display the sub-function option that matches with the main function option on the display screen 56. If the microprocessor 50 receives the select signal again, the procedure of matching the sub-function option will be carried out.

In the preferred embodiment as shown in FIGS. 2 and 3, if the search program 520 searches the setting signals in the search look up table 521 according to the external signal and no setting signal matching with the external signal is found, a notice message (such as “No such function is found.”) will be displayed on the display screen 56, and the search procedure will be ended (which is Step 3 as shown in FIG. 3).

To further understand the method of the present invention, the following example is given for illustration. After the search program 520 is started, a user can input a character string “Calculator” as the external signal by the input unit 54. The user can then press a button on the input unit 54, so that the search program 520 will search the setting signals stored in the search look up table 521. If a setting signal that matches with the character string “Calculator” is found, then the function option “Calculator” will be displayed on the display screen 56, so that a user can press the button on the input unit 54 to input the select signal, and the microprocessor 50 will execute a calculator procedure stored in the memory unit 52. The user can enter data to perform mathematical operations, or directly search the function option and enter into the procedure that matches with the selected function option, and thus saving the trouble of searching the desired function from the function options one by one.

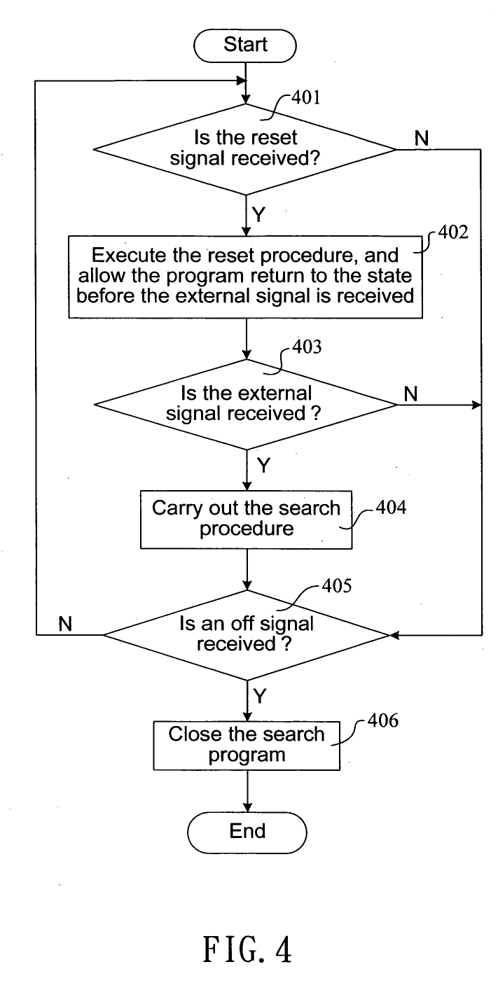

In the preferred embodiment as shown in FIG. 4, the search program 520 includes a reset program, such that after the search procedure ends, the microprocessor 50 will process the following steps:

Step 401: determining whether or not a reset signal is received; if yes, then carrying out Step 402; and if no, then carrying out Step 405;

Step 402: executing the reset procedure, so that the search program 520 returns to the state before the external signal is received;

Step 403: determining whether or not the external signal is received; if yes, then carrying out Step 404; and if no, then continuing Step 405;

Step 404: executing the search procedure;

Step 405: determining whether or not an off signal is received; if yes, then carrying out Step 406; and if no, then continuing Step 401; and

Step 406: closing the search program 520.

In the preferred embodiment as shown in FIG. 2, the reset signal and the off signal are produced by pressing the input unit 54. If the function option found in search look up table 521 by the search program 520 is not the user's desired function option or no setting signal matching with the external signal is found, the reset procedure will be executed and allow users to input the external signal again, so that the search program 520 will search the setting signals in the search look up table 521 until the user's desired function option is found.

While the invention herein disclosed has been described by means of specific embodiments, numerous modifications and variations could be made thereto by those skilled in the art without departing from the scope and spirit of the invention set forth in the claims.

What is claimed is:

1. A method for searching a function option of a mobile communication device, wherein said mobile communication device includes a microprocessor and a memory unit therein, said memory unit includes a search program, said search program includes a search procedure and a search look up table, said search look up table includes a plurality of setting signals and a plurality of function options, and said each setting signal corresponds to one of said function options; after said microprocessor receives an external signal, said method carries out a procedure comprising the steps of:
executing said search procedure after a search signal being received;
letting said search program check whether or not a setting signal matching with said external signal is found in said search look up table; and
reading said function option that matches with said setting signal, and displaying said function option on said mobile communication device when said search program finds said setting signal matching with said external signal.

2. The method of claim 1, wherein said each setting signal represents the function name of said each function option.

3. The method of claim 2, wherein said microprocessor reads a character string in said external signal and uses said character string to search any character string in said setting signals that is identical to said character string.

4. The method of claim 3, wherein said external signal and said search signal are produced by pressing an input unit of said mobile communication device.

5. The method of claim 4, wherein said function option is displayed on a display screen of said mobile communication device.

6. The method of claim 5, wherein said function options comprise a plurality of main function option and a plurality of sub-function options, and said each main function option corresponds to a plurality of sub-function options.

7. The method of claim 6, wherein said main function option is displayed on said display screen, and after said microprocessor receives a select signal, said sub-function options corresponding to said main function option are displayed on said display screen, and if said microprocessor receives said select signal again, the procedure of matching said sub-function option will be executed.

8. The method of claim 5, wherein said display screen displays a notice message and ends said search procedure, after said search program searches for said setting signals in said search look up table according to said external signal and no setting signal matching with said external signal is found.

9. The method of claim 5, wherein said search program further comprises a reset procedure, such that if said search, procedure ends, said microprocessor will carry out a procedure comprising the steps of:
executing said reset procedure, if a reset signal is determined to be received;
letting said search program return to the state before said external signal is received, and determining whether or not an off signal is received, if no more external signal is received; and
closing said search program, if said off signal is received.

10. The method of claim 9, wherein said reset signal and said off signal are produced by pressing said input unit.
